(19) United States
(12) Patent Application Publication
(10) Pub. No.: US 2009/0035626 A1
(43) Pub. Date: Feb. 5, 2009

(54) Portable hydrogen gas generator

(76) Inventors: Ying-Tso Liao, Taichung (TW); Ming-Ju Tsou, Taichung (TW); Chien-Hsin Yang, Taichung (TW)

Correspondence Address: CHARLES E. BAXLEY, ESQUIRE, 90 JOHN STREET, SUITE 309, NEW YORK, NY, 10038, US

(21) Appl. No.: 11/888,721

(22) Filed: Aug. 2, 2007

(51) Int. Cl. H01M 8/18

(52) U.S. Cl. 429/19

(57) ABSTRACT

A portable hydrogen gas generator primarily comprises a body containing a hollow reaction chamber. The reaction chamber has a material inlet and a gas outlet, wherein the material inlet allows a reaction solution and a metal material to be filled into the reaction chamber so as to perform chemical reaction therebetween. The hydrogen gas generator further comprises a gas-pressure detecting unit for detecting the status of the gas pressure in the reaction chamber, a reaction solution detecting unit for detecting the status of the reaction solution in the reaction chamber; and a gas-dispatching unit for exporting hydrogen gas in the reaction chamber to an external apparatus that consumes hydrogen gas for operation, such as a fuel cell.

### BACKGROUND OF THE INVENTION

1. Technical Field

The present invention relates to hydrogen gas generating apparatuses and, more particularly, to a hydrogen gas generator, which implements a metal material to chemically react with an acid solution or an alkaline solution so as to generate hydrogen gas and the hydrogen gas generator is easy to be carried and transported so as to free from the locational limitation

2. Description of Related Art

Industrial approach of hydrogen gas generation generally includes electrolysis, hydrocarbon pyrolysis, hydrocarbon-steam reforming, and refinery-gas extraction. However, since the above-enumerated methods require bulky devices or considerable quantities of input power, it is difficult to equip such a hydrogen gas generating apparatus at every desired location. Hence, high-pressure steel cylinders are conventionally utilized to store pre-generated hydrogen gas for facilitating transportation and storage. Due to safety concerns, such a high-pressure steel cylinder is typically made with firmness for resisting impact and bearing internal gas-pressure, and is consequently heavy and bulky. Nevertheless, only a small volume of hydrogen gas can be stored in the high-pressure steel cylinder. Even after the hydrogen gas is compressed to 150 bar, the mass of the hydrogen gas containable in the steel cylinder is less than one percent of the mass of the steel cylinder. Thus, this is not an efficient storage means. Moreover, when the hydrogen gas stored in the steel cylinder is used out, the steel cylinder has to be returned to a factory or an appointed place for refilling. Since the refilling cannot be done immediately, works subject to the use of hydrogen gas has to break off and this is quite inconvenient to users.

### SUMMARY OF THE INVENTION

A portable hydrogen gas generator primarily comprises:

a body containing a hollow reaction chamber which has a material inlet and a gas outlet, wherein the material inlet allows a reaction solution and a metal material to be filled into the reaction chamber so as to perform chemical reaction therebetween and generate hydrogen gas;

a gas-pressure detecting unit, for detecting the status of the gas pressure in the reaction chamber;

a reaction solution detecting unit, for detecting the status of the reaction solution in the reaction chamber; and

a gas-dispatching unit, for exporting hydrogen gas in the reaction chamber.

It is one objective of the present invention to provide a portable hydrogen gas generator, which utilizes chemical reaction between a reaction solution and a metal material to generate hydrogen gas directly. The disclosed hydrogen gas generator is easy to be transported and installed. By using the disclosed subject matter, hydrogen gas can be generated ceaselessly as long as the reaction solution and the metal material are repeatedly added timely. Thus, the disclosed hydrogen gas generator possesses the advantages of easy to be refilled and continuously providing hydrogen gas. Therefore, the portable hydrogen gas generator is applicable at various working sites and compatible with various external apparatuses, such as fuel cells, welding machines, etc.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic assembly drawing of the disclosed subject matter according to the present invention;

FIG. 2 is one schematic drawing showing the operation of the disclosed subject matter according to the present invention;

FIG. 3 is another schematic drawing showing the operation of the disclosed subject matter according to the present invention;

FIG. 4 is yet another schematic drawing showing the operation of the disclosed subject matter according to the present invention; and

FIG. 5 is still another schematic drawing showing the operation of the disclosed subject matter according to the present invention.

### DETAILED DESCRIPTION OF THE PREFERRED EMBODIMENT

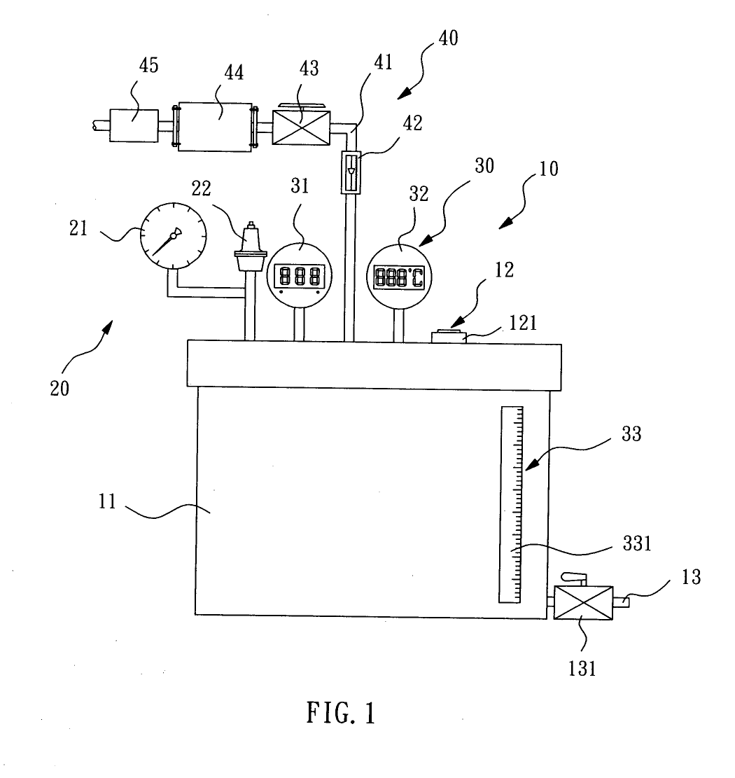

Please refer to FIG. 1 for a schematic flat drawing of a portable hydrogen gas generator according to the present invention. The primary components of the portable hydrogen gas generator are described below.

The portable hydrogen gas generator includes a body 10 containing a hollow reaction chamber 11, which is made of an acid-and-alkali resistant material. The reaction chamber 11 has a material inlet 12 and a gas outlet 13 wherein the material inlet 12 is deposited at the top of the reaction chamber 11 so as to allow a user to fill a reaction solution and a metal material into the reaction chamber 11. The reaction solution may be an acid or alkaline solution and the metal material can be aluminum. As to aluminum, in the present invention, high purity aluminum and recycled aluminum can be both applicable as the metal material where the chemical reaction relating to the generation of hydrogen gas is based on. Further, an airtight lid 121 is provided at the material inlet 12 for preventing hydrogen gas from leaking outward. In addition, the gas outlet 13 is settled at the bottom of the reaction chamber 11 and is equipped with a bottom relief valve 131 for controlling the relief of the reaction solution.

A gas-pressure detecting unit 20 comprises a gas-pressure meter 21 communicated with the reaction chamber 11 for exhibiting the gas pressure in the reaction chamber. The gas-pressure detecting unit 20 further comprises an automatic pressure-relieving device 22, which can automatically relieve pressure when the gas pressure inside the reaction chamber 11 is greater than a predetermined value so as to prevent from danger caused by excessive gas pressure.

A reaction solution detecting unit 30 comprises a reaction solution concentration meter 31 which functions for showing the current status of the reaction solution to an operator by displaying the concentration and pH value of the reaction solution, a thermometer 32 for exhibiting the temperature of the reaction solution, and a water level indicator 33, which is composed of a transparent observation window 311 disposed at outside of the body 10 and communicated with the reaction chamber 11 and a scale disposed on the observation window 311 for imaging the water level of the reaction solution in the reaction chamber 11.

A gas-dispatching unit 40 is substantially a gas-dispatching duct 41 for exporting hydrogen gas in the reaction chamber 11 to an external apparatus for utilization. The gas-dispatching unit 40 further comprises a gas flow meter 42 for detecting and displaying the flow rate in the gas-dispatching duct 41, a gas flow control valve 43, which is adjustable to control the flow rate of in the gas-dispatching duct 41 so as to meet the user's need, a gas filter 44, which is equipped with diverse physical or chemical filtering materials and capable of filtering or purifying the gas to be exported, so as to remove humidity, impurities or gas other than hydrogen gas, and a connecting device 45, which can be a joint, for connecting the gas-dispatching duct 41 with another apparatus using hydrogen gas for operation, such as a fuel cell, an oxyhydrogen flame cutting machine or a hydrogen gas filling machine.

Following the description of the construction of the present invention, the operation and principle of the present invention are hereinafter illustrated.

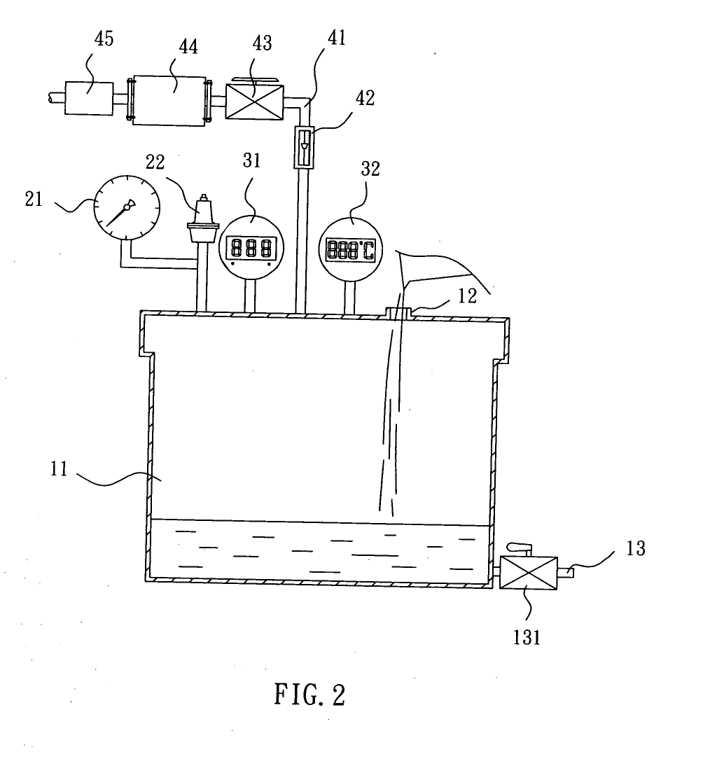

As shown in FIG. 2, when the airtight lid 121 above the material inlet 12 is opened, the reaction solution can be filled in the reaction chamber 11 through the material inlet 12. At this time, the user can read the amount of the reaction solution added from the water level indicator 33 and be aware of the current concentration or pH value of the reaction solution by means of the reaction solution concentration meter 31.

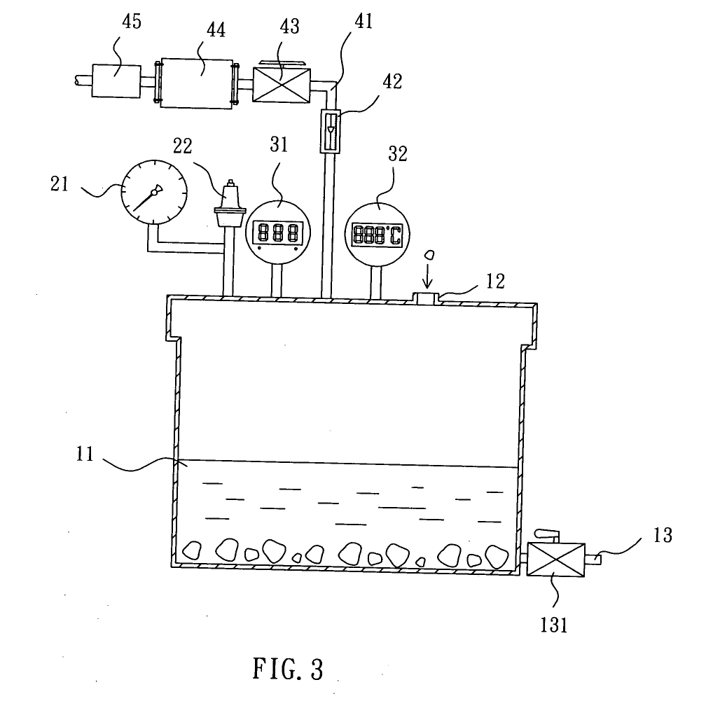

Referring to FIG. 3, after the reaction solution is added, the aluminum can be filled in the reaction chamber 11 through the material inlet 12 and then the airtight lid 121 is tightly closed.

Since the reaction solution is an acid or alkaline solution, the aluminum entering the reaction chamber 11 will react with the reaction solution, and the respective reaction equations are:

(1) Aluminum reacts with alkali to generate hydrogen gas:

2Al(s)+2OH⁻+6H₂O==>2Al(OH)₄⁻+3H₂(g)↑

(2)Aluminum reacts with acid to generate hydrogen gas:

2Al(s)+6H+==>2Al₃⁺+3H₂(g)↑

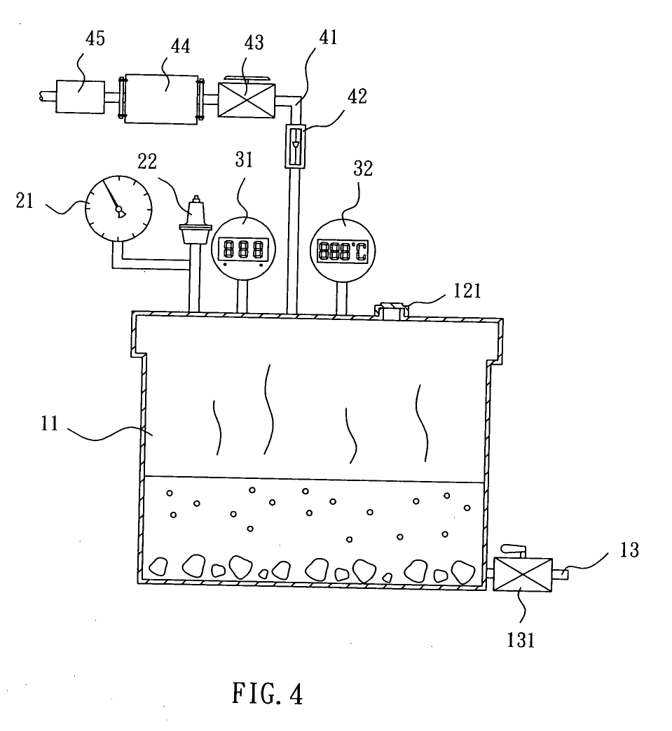

Please refer FIG. 4, while aluminum reacts with acid to generate hydrogen gas, the user can read the gas pressure in the reaction chamber 11 from the gas-pressure meter 21. Once the gas pressure in the reaction chamber 11 reaches an effective value, the user can open the gas flow control valve 43. When the exportation of gas begins, the gas flow meter 42 can detect and display the gas flow in the gas-dispatching duct 41 so that the user can adjust the gas flow at need so as to export the generated hydrogen gas to an external apparatus that consumes hydrogen gas for operation.

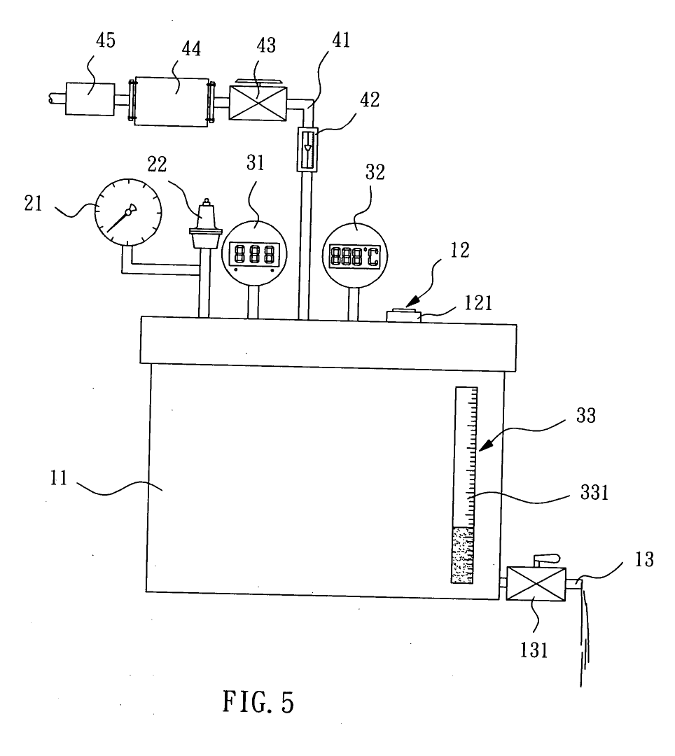

The user can learn the consumption of the reaction solution through the reading of the reaction solution concentration meter 31. When the concentration of the reaction solution is excessively low, it denotes that the hydrogen gas is going to be used out. Then after the hydrogen gas is completely consumed and the reading of the gas-pressure meter 21 decreases to a normal level, the user can open the bottom relief valve 131 to relieve the waste solution (as shown in FIG. 5). At this time, the user can check whether the waste solution is completely discharged via the water level indicator 33 so as to prevent that the residual waste solution affects the efficiency of the subsequent reactions. After the waste solution is completely discharged, the user can easily refill the reaction solution and the metal material and the hydrogen gas generator can proceed to generate hydrogen gas.

During the reaction between the aluminum and the reaction solution, the user can monitor the reaction velocity through the reading of the thermometer 32. If the reading of the thermometer 32 abruptly increases, it is suggested that the current reaction between the aluminum and the reaction solution is excessively acute and may incur danger so that the user can immediately open the bottom relief valve 131 to relieve part of the reaction solution to moderate the reaction velocity and avoid potential danger.

For providing diverse reaction velocity of hydrogen gas generation for matching the needs of diverse apparatuses, the aluminum can be prepared as blocks, strips, pieces, particles or powders so that the user can easily adjust the reaction velocity by implementing aluminum prepared in different sizes. For instance, when a relatively larger output in a unit time is required, aluminum of a smaller size can be used. Thereby, the adjustment of the reaction velocity is simple and convenient.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A portable hydrogen gas generator, primarily comprising:
a body, containing a hollow reaction chamber which has a material inlet and a gas outlet, wherein the material inlet allows a reaction solution and a metal material to be filled into the reaction chamber so as to perform a chemical reaction therebetween and generate hydrogen gas;
a gas-pressure detecting unit, for detecting status of gas pressure in the reaction chamber;
a reaction solution detecting unit, for detecting status of the reaction solution in the reaction chamber; and
a gas-dispatching unit, for exporting the hydrogen gas generated in the reaction chamber.

2. The portable hydrogen gas generator of claim 1, wherein, the metal material is aluminum.

3. The portable hydrogen gas generator of claim 2, wherein, the metal material is formed as blocks, strips, pieces, particles or powders.

4. The portable hydrogen gas generator of claim 1, wherein, the reaction solution is an alkaline solution.

5. The portable hydrogen gas generator of claim 1, wherein, the reaction solution is an acid solution.

6. The portable hydrogen gas generator of claim 1, wherein, the material inlet is deposited at top of the reaction chamber and is equipped with an airtight lid.

7. The portable hydrogen gas generator of claim 1, wherein, the gas outlet is settled at bottom of the reaction chamber and is equipped with a bottom relief valve for controlling relief of the reaction solution.

8. The portable hydrogen gas generator of claim 1, wherein, the gas-pressure detecting unit comprises a gas-pressure meter communicated with the reaction chamber for exhibiting the gas pressure in the reaction chamber.

9. The portable hydrogen gas generator of claim 8, wherein, the gas-pressure detecting unit comprises an automatic pressure-relieving device, which can automatically relieve pressure when the gas pressure inside the reaction chamber is excessive.

10. The portable hydrogen gas generator of claim 1, wherein, the reaction solution detecting unit comprises a reaction solution concentration meter.

11. The portable hydrogen gas generator of claim 10, wherein, the reaction solution concentration meter functions for showing pH value of the reaction solution.

12. The portable hydrogen gas generator of claim 1, wherein, the reaction solution detecting unit comprises a thermometer for exhibiting temperature of the reaction solution.

13. The portable hydrogen gas generator of claim 1, wherein, the reaction solution detecting unit comprise a water level indicator for imaging water level of the reaction solution.

14. The portable hydrogen gas generator of claim 1, wherein, the water level indicator is composed of a transparent observation window disposed at outside of the body and communicated with the reaction chamber, and a scale disposed on the observation window for imaging the water level of the reaction solution in the reaction chamber.

15. The portable hydrogen gas generator of claim 1, wherein, the gas-dispatching unit comprises a gas flow meter.

16. The portable hydrogen gas generator of claim 1, wherein, the gas-dispatching unit comprises a gas flow control valve.

17. The portable hydrogen gas generator of claim 1, wherein, the gas-dispatching unit comprises a gas filter.

18. The portable hydrogen gas generator of claim 1, wherein, the gas-dispatching unit comprises a connecting device.

19. The portable hydrogen gas generator of claim 18, wherein, the connecting device is a joint.

20. The portable hydrogen gas generator of claim 18, wherein, the connecting device is connected to an external apparatus that consumes hydrogen gas for operation, such as a fuel cell or a welding machine.
